(19) United States
(12) Patent Application Publication
(10) Pub. No.: US 2013/0218971 A1
(43) Pub. Date: Aug. 22, 2013

(54) CLOUD PLATFORM NOTIFICATION

(71) Applicant: SAMSUNG ELECTRONICS, CO., LTD., (US)

(72) Inventors: Curtis Sasaki, Sunnyvale, CA (US); Kuldip S. Pabla, San Jose, CA (US); Guangshun Chen, Saratoga, CA (US)

(73) Assignee: SAMSUNG ELECTRONICS, CO., LTD., SUWON (KR)

(21) Appl. No.: 13/764,469

(22) Filed: Feb. 11, 2013

Related U.S. Application Data
(60) Provisional application No. 61/597,099, filed on Feb. 9, 2012.

(51) Int. Cl. H04L 29/08

(52) U.S. Cl. CPC H04L 29/08081
USPC 709/204

(57) ABSTRACT

Providing updates for event notifications comprises identifying a first event. The first event is associated with one or more knowledge sources. Updates related to the first event based on the one or more knowledge sources are obtained. Related updates having an impact on the first event are determined. An electronic device is notified with the related updates having an impact on the first event.

### CROSS-REFERENCE TO RELATED APPLICATION

This application claims the priority benefit of U.S. Provisional Patent Application Ser. No. 61/597,099, filed on Feb. 9, 2012, incorporated herein by reference.

### TECHNICAL FIELD

An embodiment of the present invention generally relates to event updates, and in particular to updates that impact events in mobile communication devices.

### BACKGROUND

With the rapid proliferation of mobile communication devices such as smartphones amongst users such as teenagers and children there is an increase in use of applications, such as calendars for appointment and event reminders via such devices.

### SUMMARY

An embodiment of the present invention generally relates to updates for event notifications. One embodiment of the invention provides updates for event notifications comprises identifying a first event. The first event is associated with one or more knowledge sources. Updates related to the first event based on the one or more knowledge sources are obtained. Related updates having an impact on the first event are determined. An electronic device is notified with the related updates having an impact on the first event.

Another embodiment includes a computer program product for providing updates for event notifications. The computer program product comprising: a tangible storage medium readable by a computer system and storing instructions for execution by the computer system for performing a method comprising: identifying a first event. The first event is associated with one or more knowledge sources. Updates related to the first event based on the one or more knowledge sources are obtained. Related updates having an impact on the first event are determined. An electronic device is notified with the related updates having an impact on the first event.

One embodiment comprises an electronic device including a detector that detects first event information content on the electronic device. In one embodiment, an update module obtains updates related to the first event information, determines the updates that have an impact on the first event, and notifies the electronic device with the related updates having an impact on the first event.

These and other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a block diagram of an architecture for relevant updates for events on a mobile device, according to an embodiment of the invention.

FIG. 2 shows a flowchart of an event aggregation process with event application integration on an electronic device for determining unexpected changes in events based on sub-events, according to an embodiment of the invention.

FIG. 3 shows a flowchart of an event update process for updating an electronic device, according to an embodiment of the invention.

FIG. 4 is a high-level block diagram showing an event update processing system comprising a computing system implementing an embodiment of the present invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

An embodiment of the present invention generally relates to event updates and in particular, to updates that impact events in electronic devices, such as mobile communication devices. In one embodiment, providing updates for event notifications comprises identifying a first event. In one embodiment, the first event is associated with one or more knowledge sources. In one embodiment, updates related to the first event based on the one or more knowledge sources are obtained. In one embodiment, related updates having an impact on the first event are determined. In one embodiment, an electronic device is notified with the related updates having an impact on the first event. In one embodiment, notification via the electronic device includes communication, transmission, reception, origination, and updating of content via the electronic device, as described in more detail hereinbelow.

In one embodiment, the invention provides a real-time system to identify events that have an impact on other events. In one embodiment, the invention provides a real-time system to resolve dependencies of events and store the dependencies. In one embodiment, the invention provides a real-time system for aggregating event related information, check for any changes, and notify an electronic device for a user to take a relevant action.

In one embodiment, the system is not internet-based and does not require server validation (such as SMSC/MMSC or sending out the content to a server located in the network). The system is suitable for a mobile device environment wherein at least a portion of content validation is performed on the device itself in real time.

In one embodiment the invention provides an end-to-end proactive process for detecting updates related to events and provides notification of the related updates that impact events.

In one implementation, the invention provides a real-time, end-to-end, device-integrated protocol and system for mobile communication devices such as wireless mobile communication devices (e.g., smartphones and tablets) to proactively enhance user experience by alerting an electronic device when there is an unexpected change in an event (e.g., an appointment, a flight, etc.) due to one or more related events. In one implementation, the invention takes out guessing impacts of any related events, and automatically updates applications, such as user calendars, keeping the application updated for events. In one implementation, the invention enhances user experience by accounting for user behavior or history of usage of various electronic device and application features.

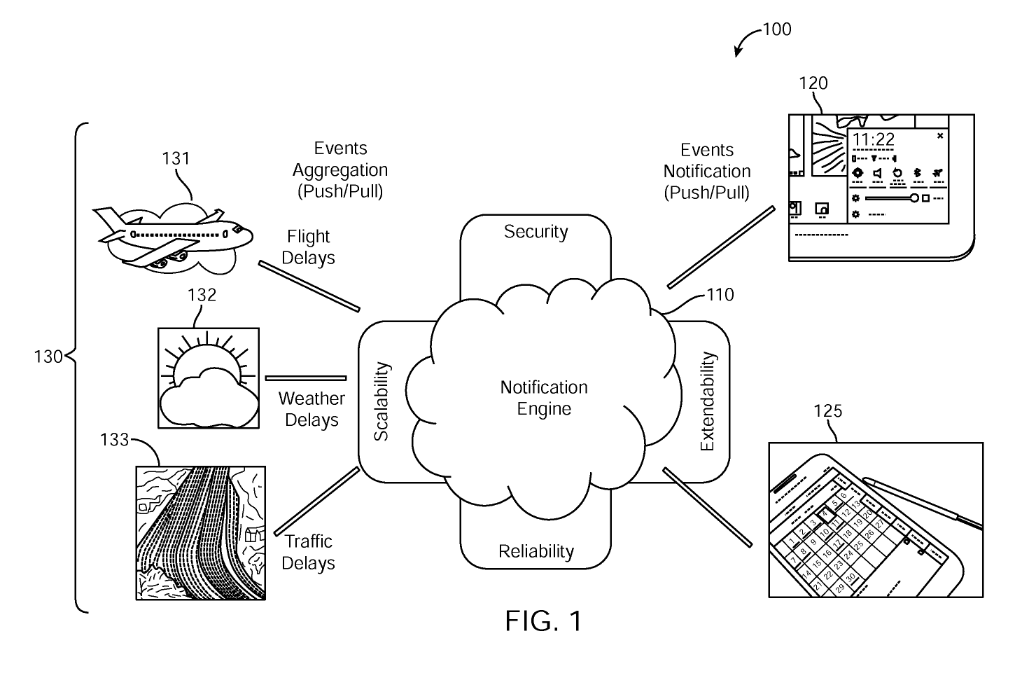

FIG. 1 shows a block diagram of architecture 100 for a notification engine 110 that may be executed on a mobile device 125, in a cloud environment architecture (e.g., a cloud server(s) or network), or a combination of the mobile device 125 and a cloud environment architecture, for aggregating updates and determining relevant updates that have an effect on an event on the mobile device 125. In one embodiment, the notifications from event updates may be alerted to a user through a display of one or more applications 120 or via sound/vibration (e.g., images, videos, texts, emails) that may be pushed/pulled to/from the mobile device 125. In one embodiment, event aggregation of smaller events 130 that effect a larger event (e.g., a calendar appointment, scheduled event, scheduled flight, etc.) are aggregated and used for determining whether the larger events will be effected so that an alert or suggestion may be generated on the mobile device 125.

In one embodiment, the notification engine 110 obtains information for the smaller events 130, such as flight delay information 131, weather delay information 132, traffic delay information 133, waiting times (e.g., wait times at restaurants, movie theatres, airport terminals, parking facilities, etc.), etc. In one embodiment, the notification engine 110 uses the obtained information for the smaller events 130 and determines whether the obtained information has an effect on a larger event. For example, traffic delay 133 information may be used to determine that a next scheduled appointment may be in jeopardy based on determining a current location of the mobile device 125. Information, such as previous known travel times, known distance and current traffic speed, etc. may be used to determine the amount of time that it is estimated to take to arrive at a different location for a larger event (e.g., a meeting, scheduled event (e.g., a movie, a flight, a bus, a train, etc.), desired location, etc.). Additionally, bad weather information resulting in weather delay information 132 (e.g., snow, hail, visibility, rain, etc.) may also add to additional delay time that may effect scheduled time for a larger event.

In one embodiment, a portion of event processing of smaller events 130 for a larger event may be processed in a cloud platform environment server(s) to relieve processing for the mobile device 125. In this embodiment, sudden event changes or the detection of these sudden event changes may be processed directly on the mobile device 125. In one example, processing for smaller events 130, such as flight delays 131, weather delays 132 and traffic delays 133, may be handled by the cloud platform environment server(s), while sudden event changes (e.g., time change, venue change, cancellation, etc.) are processed by the mobile device 125. In one implementation, depending on processing requirements of smaller events 130, a threshold may be selected for determining which smaller event 130 processing will take place on the mobile device 125 and which processing will occur on the cloud platform environment server(s). In another embodiment, only user specified types of sudden changes to events are processed on the mobile device 125.

In one embodiment, a major event for a user of a mobile device 125 may depend on an arrival of another person prior to departure for a scheduled larger event. For example, if a first user has a scheduled flight to leave at a particular time, other aggregated smaller events may effect the user from making the scheduled flight. The first user may have to wait for another user to arrive at a destination so that both users may travel to an airport. Information from the estimated arrival time of the second user to the departure location prior to leaving for an airport may be used to determine whether an alert should be made to the mobile device 125. In one implementation, the first user may have scheduled a departure time for the airport at a first time. Based on obtaining smaller event 130 information, and the estimated arrival time for the second user, an alert may be made suggesting that an earlier departure time should be take place.

In another implementation, the smaller events 130 are analyzed by the notification engine 110 to determine the aggregated delays that may be combined to result in a total delay that effects a larger event in order to generate a notification on the mobile device 125. In one embodiment, information for the smaller events 130 may be obtained from knowledge sources, such as weather information sources, traffic information sources, flight schedule sources, etc. The known sources may be obtained based on location. For example, if a larger event is a scheduled meeting at an office after a scheduled flight, then current location information is used for local traffic, weather and flight information. Upon arrival at the destination airport, the new local information for weather, traffic, etc. is obtained to determine whether a notification should be generated. In one implementation, based on the known estimated arrival time, and the destination local traffic and weather information, the notification engine 110 determines whether a user will be on time for a scheduled event (e.g., meeting, reservations, appointment, etc.). If the notification engine 110 determines that the aggregated delays will effect making the scheduled event on time, a notification is made to the mobile device 125. With the enhancements of the various implementations and embodiments of the invention, a user may inform others to expect a delay or whether they are currently on schedule.

In one embodiment, changes to smaller events 130 of a first larger/mega event effects changes in another larger/mega event. For example, a first larger/mega event may comprise taking a flight from Los Angeles to New York City, and a flight from New York City to London. A second larger/mega event may comprise taking a train from London to Paris. If there are weather delays in New York City that result in flight delays to the flight to London, this could also impact the second larger/mega event of taking the train from London to Paris. In one embodiment, the notification engine 110 analyzes the larger/mega events to determine the aggregated delays that may be combined to result in a total delay that effects other larger events in order to generate a notification on the mobile device 125. In one embodiment, the delay from one larger/mega event that results in a change to another larger/mega event may result in processing on a cloud platform environment server(s) to obtain schedules for alternate events, such as alternate flight schedules on other airlines, alternate train schedules, etc. The mobile device 125 may then pull the alternate event information and notify the user with the alternate suggestions.

In one embodiment, the notifications communicated on the mobile device 125 may suggest actions for a user to take, such as send an email or text message to appointment participants, schedule a new event, leave early for a destination, prepare for delays, etc. In one embodiment, the email or text message may be manually prepared by a user of the mobile device 125, automatically prepared by the mobile device 125, automatically prepared by the cloud server, or automatically prepared by a combination of the electronic device and the cloud server 120. In one embodiment, the notification engine 110 tracks user behavior and usage history of one or more features of the mobile device 125, and adjusts and updates applications, such as a calendar application, based on the tracked user behavior and usage history of the one or more features. In one implementation, the usage features may include global positioning system (GPS) information, travel times, routes, traffic time/date based history, etc. In one example, based on tracked history of user travel habits, the notification engine 110 may generate a notification on the mobile device 125 informing the user whether they are late, on time, need to leave earlier, etc. In one example, if a user is delayed for an event for any reason, the notification engine 110 may send a text message or email message (e.g., generated on the electronic device 125, generated on the cloud server, or generated on a combination of the electronic device 125 and the cloud server) to event participants informing them that one or more of the participants is running late (i.e., delaying the event) so that the other participants may plan/schedule/prepare, etc; accordingly.

In one embodiment, the notification engine 110 includes a detector that detects first event information content on the electronic device (e.g., calendar information, appointment information, reservations, scheduled flight information, etc.), and an update module that obtains updates related to the first event information. The notification engine 110 determines the updates that have an impact on the first event (e.g., delay information, weather information, flight information, etc.), and notifies the electronic device with the related updates having an impact on the first event.

In one embodiment, the notification engine 110 creates an alert (e.g., text, video, sound, speech, vibration, etc.) on the mobile device 125 upon an unexpected change to the scheduling for an event based on a related event (e.g., smaller event 130). In one implementation, the update module of the notification engine 110 validates the updates related to the larger event in real time (or near real-time) in the mobile device 125 by analyzing the updates, and filtering the updates on the electronic device based on whether they effect the larger event or not. In one implementation, a tracking module of the notification engine 110 tracks user behavior and usage history of one or more features of the mobile device 125, and the update module adjusts updates of applications (e.g., calendars, appointments, reservations, scheduled flights, etc.) based on the tracked user behavior and usage history of the one or more features. In one embodiment, a text-to-speech process may be implemented on the electronic device 125 such that notifications may be converted to speech and output from the electronic device 125 for a user to listen.

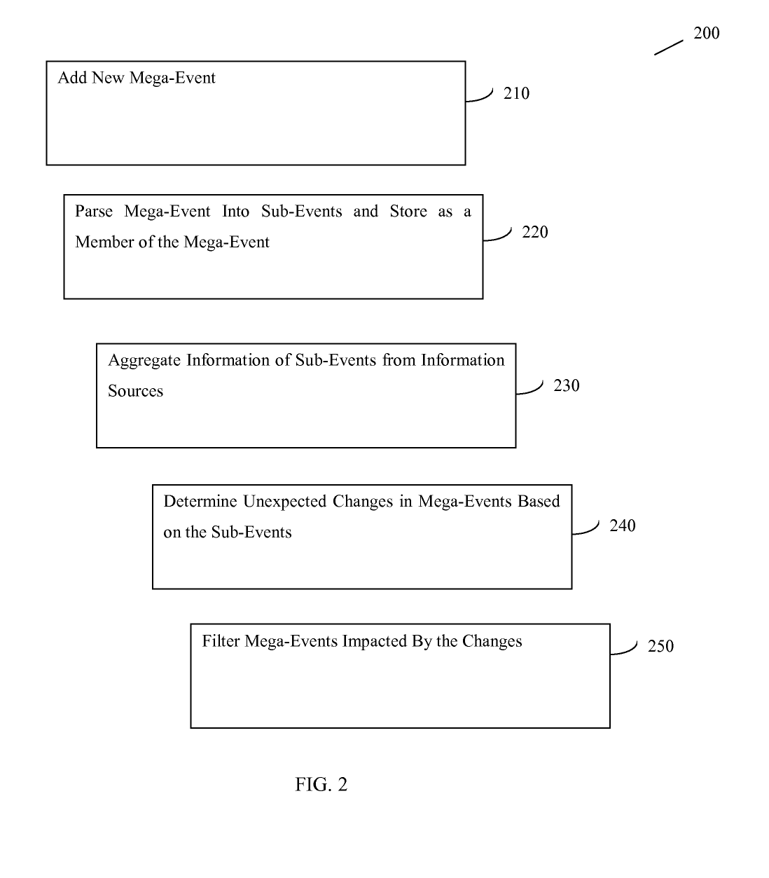

FIG. 2 shows a flowchart of an event aggregation process 200 for update notification on a mobile device (such as wireless mobile phone or tablet device), according to an embodiment of the invention. The mobile device includes applications for events, such as applications for calendaring, appointments, reservations, scheduled transportation (e.g., flights, trains, busses, ships/boats, etc.). The mobile device also includes features, such as GPS, mapping, Internet capability, etc. The event aggregation process 200 is integrated with the mobile device functions (i.e., location information, mapping, Internet functionality, etc.) for analyzing event update information and filtering out non-relevant update information.

In process block 210, a new mega-event or main event (e.g., an appointment, meeting, reservation, etc.) is added to an application of the mobile device. In process block 220, the added mega-event is parsed into sub-events and stored as a member of the mega-event (e.g., associated with the mega-event). Process block 230 comprises aggregating information of the sub-events from one or more information sources (e.g., traffic information sources, weather information sources, transportation information sources, etc.). The one or more information sources comprise information for one or more real-time conditions that alter or have an effect on the mega-event. Process block 240 comprises determining unexpected changes in mega-events based on the sub-events. For example, an unexpected change may be a traffic delay caused by an accident, weather delays, flight delays, where the unexpected changes may be either local or destination based (e.g., location of flight destination). Information is obtained from the mobile device for determining an effect of the related updates on the mega-event. Process block 250 filters mega-events that are impacted by the unexpected changes. In one implementation, the unexpected changes may comprise any change that impacts a scheduled event. In one embodiment, the impacts may be negative (e.g., delay of a scheduled event) or positive (an event that results in addition of time or time savings). In one embodiment, the updates related to the mega-event are validated in real time (or near real-time) in the mobile device by analyzing the updates, and filtering the updates on the mobile device. In one implementation, the event aggregation process 200 automatically updates applications, such as calendars, on one or more mobile devices based on the related updates that impact the mega-event.

In one embodiment, the event aggregation process 200 tracks user behavior and usage history of one or more features of the mobile device, and adjusts updates of event applications, such as calendars, based on the tracked user behavior and usage history of the one or more features.

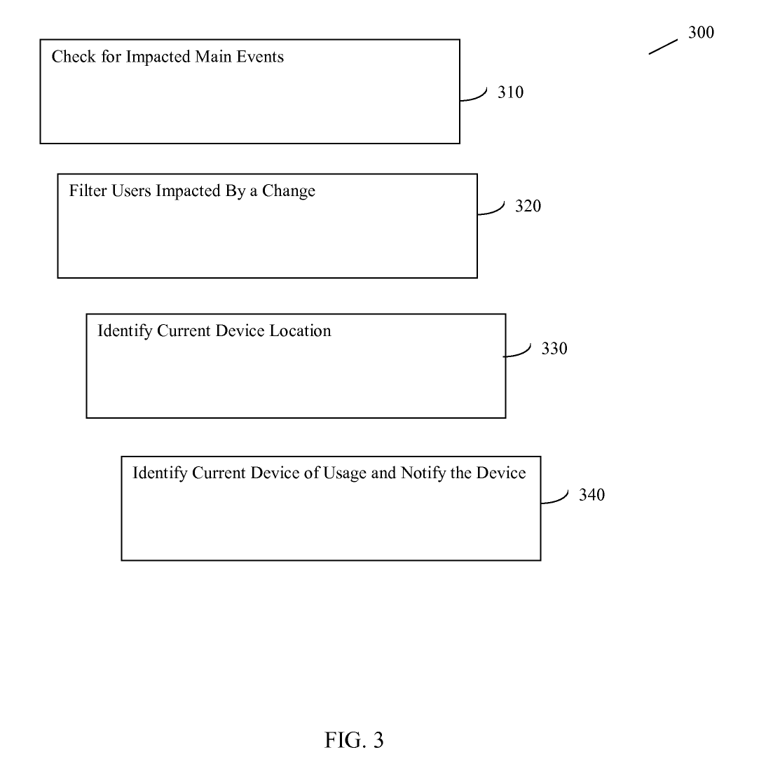

FIG. 3 shows a flowchart of an event update notification process 300 for notifying a mobile device (such as wireless mobile phone or tablet device), according to an embodiment of the invention. The mobile device can wirelessly communicate information. The event update notification process 300 is integrated with the mobile device functions (e.g., GPS, mapping, Internet) for analyzing event updates and filtering out updates that are not relevant to a main event (e.g., calendaring appointment, scheduled meeting, scheduled transportation, reservation, etc.), and alerting the mobile device of impacted main events.

Process block 310 comprises checking main events that are impacted, for example, from events causing delays (e.g., traffic events, weather events, flight events, etc.). In process block 320, users associated with the main event that are impacted by an unexpected change are filtered out. In process block 330, the current location of the mobile device is identified (e.g., using GPS, mapping, user entered information, etc.). In process block 340, a mobile device currently being used is identified and notified of the changes to a main event based on the updates. In one example, a user of mobile devices may have multiple devices that each includes an event application (e.g., calendaring application). In one implementation, the mobile device that is currently being used is identified. In one implementation, the current device in use may be identified based on movement of the device (e.g., using GPS, using gyroscopic device, using user feedback, etc.). Once the mobile device in use is identified, the mobile device may then be notified with an alert (e.g., text, sound, vibration, video, speech, etc.).

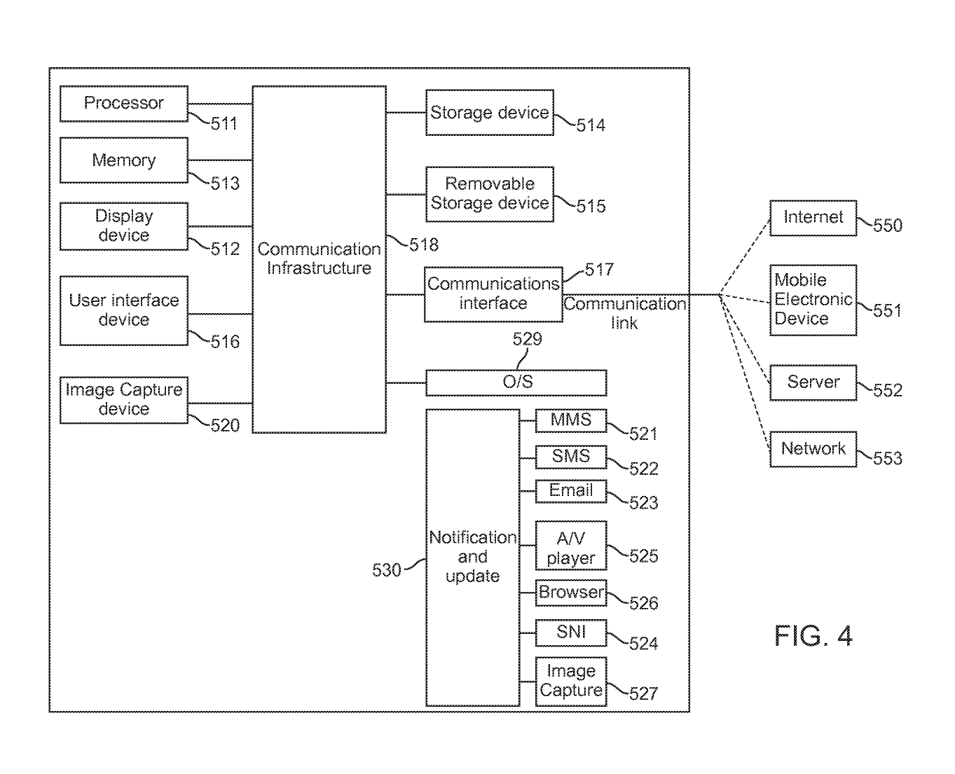

FIG. 4 is a high-level block diagram showing an information processing system comprising a computing system 500 implementing an embodiment of the present invention. The system 500 includes one or more processors 511 (e.g., ASIC, CPU, etc.), and can further include an electronic display device 512 (for displaying graphics, text, and other data), a main memory 513 (e.g., random access memory (RAM)), storage device 514 (e.g., hard disk drive), removable storage device 515 (e.g., removable storage drive, removable memory module, a magnetic tape drive, optical disk drive, computer readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card). The communication interface 517 allows software and data to be transferred between the computer system and external devices. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of the invention in a mobile wireless device such as a mobile phone, the system 500 further includes an image capture device such as a camera 520. The system 500 further includes application modules at which content terminates/originates such as MMS module 521, SMS module 522, e-mail module 523, social network interface (SNI) module 524, audio/video (AV) player 525, web browser 526, image capture module 527, etc.

The system 500 further includes a notification and update module 530 as described herein, according to an embodiment of the invention. The notification and update module 530 performs event update (e.g., calendar events, appointment events, reservation events, scheduled transportation events, etc.) and notification (e.g., alerts, reminders, notices, etc.) on the system 500 in real time, such as described herein in relation to FIGS. 1-3. Example implementation of the update and notification module 530 is the notification engine 110 in FIG. 1.

In one implementation of said application modules, content validation modules along with an operating system 529 may be implemented as executable code residing in a memory of the system 500. In another embodiment, such modules are in firmware, etc. Preferably, the content validation modules cannot be uninstalled from the device and the user will not have any way to disable the content validation features. Hence, the content validation is embedded into the operating system or firmware of the device at various levels (e.g., libraries, framework levels, etc.). The content validation modules are integrated with said application modules to provide content validation according to embodiments of the invention.

In one example, the event update and notification integration is implemented as code (e.g., utilizing API of the application modules) for obtaining update information, filtering out update information, and determining impacts to events in the application modules and providing notification of impacted events to a mobile device.

In one embodiment, the system 500 may communicate with one or more of Internet 550, mobile electronic device 551, server 552, network 553 in a wire and/or wireless manner.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the invention.

Though the present invention has been described with reference to certain versions thereof; however, other versions are possible. Therefore, the spirit and scope of the appended claims should not be limited to the description of the preferred versions contained herein.

What is claimed is:

1. A method for providing updates for event notifications, comprising:
identifying a first event;
associating the first event with one or more knowledge sources;
obtaining updates related to the first event based on the one or more knowledge sources;
determining related updates having an impact on the first event; and
notifying an electronic device with the related updates having an impact on the first event.

2. The method of claim 1, wherein:
the one or more knowledge sources comprise information for one or more real-time conditions that alter the first event.

3. The method of claim 2, wherein the one or more real-time conditions each has an effect on the first event.

4. The method of claim 1, further comprising obtaining information from the electronic device for determining an effect of the related updates on the first event.

5. The method of claim 4, wherein notifying the electronic device comprises creating an alert on the electronic device upon an unexpected change to the first event based on a related event.

6. The method of claim 1, further comprising:
validating the updates related to the first event in real time in the electronic device by analyzing the updates, and filtering the updates on the electronic device.

7. The method of claim 2, further comprising:
automatically updating calendars on one or more electronic devices based on the related updates that impact the first event.

8. The method of claim 7, further comprising:
tracking user behavior and usage history of one or more features; and
adjusting updates of calendars based on the tracked user behavior and usage history of the one or more features.

9. The method of claim 1, wherein the one or more knowledge sources comprise one or more of: transportation information, weather information, and traffic information.

10. The method of claim 1, wherein the electronic device comprises a wireless mobile communication device.

11. A computer program product for providing updates for event notifications, the computer program product comprising:
a tangible storage medium readable by a computer system and storing instructions for execution by the computer system for performing a method comprising:
identifying a first event;
associating the first event with one or more knowledge sources;
obtaining updates related to the first event based on the one or more knowledge sources;
determining related updates having an impact on the first event; and
notifying an electronic device with the related updates having an impact on the first event.

12. The computer program product of claim 11, wherein:
the one or more knowledge sources comprise information for one or more real-time conditions that alter the first event.

13. The computer program product of claim 11, further comprising obtaining information from the electronic device for determining an effect of the related updates on the first event.

14. The computer program product of claim 13, wherein:
notifying the electronic device comprises creating an alert on the electronic device upon an unexpected change to the first event based on a related event.

15. The computer program product of claim 14, further comprising:
validating the updates related to the first event in real time in the electronic device by analyzing the updates, and filtering the updates on the electronic device.

16. The computer program product of claim 12, further comprising:
automatically updating calendars on one or more electronic devices based on the related updates that impact the first event;
tracking user behavior and usage history of one or more features; and
adjusting updates of calendars based on the tracked user behavior and usage history of the one or more features.

17. The computer program product of claim 11, wherein:
the one or more knowledge sources comprise one or more of: transportation information, weather information, and traffic information.

18. The computer program product of claim 11, wherein the electronic device comprises a wireless mobile communication device.

19. An electronic device, comprising:
a detector that detects first event information content on the electronic device; and
an update module that obtains updates related to the first event information, determines the updates that have an impact on the first event, and notifies the electronic device with the related updates having an impact on the first event.

20. The electronic device of claim 19, wherein:
the update module obtains the updates related to the first event information from one or more knowledge sources.

21. The electronic device of claim 20, wherein:
the knowledge sources comprise information for one or more real-time conditions that alter the first event.

22. The electronic device of claim 21, wherein:
the update module notifies the electronic device based on creating an alert on the electronic device upon an unexpected change to the first event based on a related event.

23. The electronic device of claim 22, wherein:
the update module validates the updates related to the first event in real time in the electronic device by analyzing the updates, and filtering the updates on the electronic device.

24. The electronic device of claim 23, wherein:
the update module automatically updating calendars on one or more electronic devices based on the related updates that impact the first event.

25. The electronic device of claim 24, further comprising:
a tracking module that tracks user behavior and usage history of one or more features; and the update module adjusts updates of calendars based on the tracked user behavior and usage history of the one or more features.

26. The electronic device of claim 25, wherein:
the one or more knowledge sources comprise one or more of: transportation information, weather information, and traffic information.

27. The electronic device of claim 26, wherein the electronic device comprises a wireless mobile communication device.

28. The electronic device of claim 19, wherein event processing is performed on one of the electronic device, a cloud platform server, or a combination of the electronic device and the cloud platform server.

29. The electronic device of claim 28, wherein sudden changes to one or more related events are processed on the electronic device.

30. The electronic device of claim 29, wherein changes in related events of the first event effects changes in a second event.
